(19) United States
(12) Patent Application Publication
(10) Pub. No.: US 2010/0223123 A1
(43) Pub. Date: Sep. 2, 2010

(54) Systems and Methods for Sending Content to a Website on a Network of Websites

(76) Inventor: Kamakshi Sivaramakrishnan, Mountain View, CA (US)

Correspondence Address: CARR & FERRELL LLP, 2200 GENG ROAD, PALO ALTO, CA, 94303, US

(21) Appl. No.: 12/715,305

(22) Filed: Mar. 1, 2010

Related U.S. Application Data
(60) Provisional application No. 61/208,739, filed on Feb. 27, 2009.

(51) Int. Cl. G06Q 30/00

(52) U.S. Cl. 705/14.42

(57) ABSTRACT

Provided are exemplary systems and methods for sending an electronic advertisement to a predetermined mobile website on a network of mobile websites. Exemplary methods include receiving an electronic advertisement for sending to a predetermined mobile website on a network of mobile websites, determining for the predetermined mobile website a first predetermined model that best fits a click-through rate for the predetermined mobile website, sending a first sampling of the electronic advertisement to the predetermined mobile website per the first predetermined model, sending a second sampling of the electronic advertisement to the predetermined mobile website per a second predetermined model, determining a click-through rate for each sampling of electronic advertisements sent to the predetermined mobile website for each of the respective predetermined models, calibrating each of the predetermined models based on its associated click-through rate, selecting the predetermined model with the highest associated click-through rate, and sending the electronic advertisement to the predetermined mobile website per the calibrated selected predetermined model.

### CROSS-REFERENCE TO RELATED APPLICATION

This application claims the benefit and priority of U.S. Provisional Patent Application Ser. No. 61/208,739 titled “Systems and Methods for Sending Content to a Website on a Network of Websites,” filed on Feb. 27, 2009, which is hereby incorporated by reference.

### BACKGROUND OF THE INVENTION

### FIELD OF THE INVENTION

This invention relates to the delivery of content over networks, and more particularly to the sending of content to a predetermined website on a network of websites.

### BRIEF SUMMARY OF THE INVENTION

Provided herein are exemplary systems and methods for sending an electronic advertisement to a predetermined mobile website on a network of mobile websites. Exemplary methods include receiving an electronic advertisement for sending to a predetermined mobile website on a network of mobile websites, determining for the predetermined mobile website a first predetermined model that best fits a click-through rate for the predetermined mobile website, sending a first sampling of the electronic advertisement to the predetermined mobile website per the first predetermined model, sending a second sampling of the electronic advertisement to the predetermined mobile website per a second predetermined model, determining a click-through rate for each sampling of electronic advertisements sent to the predetermined mobile website for each of the respective predetermined models, calibrating each of the predetermined models based on its associated click-through rate, selecting the predetermined model with the highest associated click-through rate, and sending the electronic advertisement to the predetermined mobile website per the calibrated selected predetermined model. Further exemplary methods include sending a third sampling of the electronic advertisement to the predetermined mobile website per a third predetermined model, determining a click-through rate for the third sampling of electronic advertisements sent to the predetermined mobile website per the third predetermined model, calibrating the third predetermined model based on its associated click-through rate, selecting the predetermined model with the highest associated click-through rate, and sending the electronic advertisement to the predetermined mobile website per the calibrated selected predetermined model.

Exemplary systems for sending an electronic advertisement to a predetermined mobile website on a network of mobile websites includes a transmission module for receiving an electronic advertisement for sending to the predetermined mobile website on the network of mobile websites, an analytic component in communication with the transmission module, the analytic component determining for the predetermined mobile website a first predetermined model that best fits a click-through rate for the predetermined mobile website, the transmission module sending a first sampling of the electronic advertisement to the predetermined mobile website per the first predetermined model, the transmission module sending a second sampling of the electronic advertisement to the predetermined mobile website per a second predetermined model as determined by the analytic component, a calculation component in communication with the transmission module and the analytic component, the calculation component determining a click-through rate for each sampling of electronic advertisements sent to the predetermined mobile website for each of the respective predetermined models, a calibration component in communication with the transmission module, the analytic component, and the calculation component, the calibration component calibrating each of the predetermined models based on its associated click-through rate, a selection component in communication with the transmission module, the analytic component, the calculation component, and the calibration component, the selection component selecting the predetermined model with the highest associated click-through rate, and the transmission module sending the electronic advertisement to the predetermined mobile website per the calibrated selected predetermined model. Further exemplary systems include the transmission module sending a third sampling of the electronic advertisement to the predetermined mobile website per a third predetermined model, the calculation component determining a click-through rate for the third sampling of electronic advertisements sent to the predetermined mobile website per the third predetermined model, the calibration component calibrating the third predetermined model based on its associated click-through rate, the selection component selecting the predetermined model with the highest associated click-through rate, and the transmission module sending the electronic advertisement to the predetermined mobile website per the calibrated selected predetermined model.

### BRIEF DESCRIPTION OF THE DRAWINGS AND THE APPENDICES

FIG. 1 shows click-through rate characteristics in general, based on advertisements and websites.

FIG. 2 shows an exemplary layout by which a predetermined model (i.e. “winning strategy”) with the highest associated click-through rate may be determined.

FIG. 3 is a flow chart of an exemplary method for sending an electronic advertisement to a predetermined mobile website on a network of mobile websites.

FIG. 4 shows one exemplary system for sending an electronic advertisement to a predetermined mobile website on a network of mobile websites.

Appendix 1 is an exemplary predetermined model for sending an electronic advertisement to a predetermined mobile website on a network of mobile websites.

Appendix 2 shows additional exemplary predetermined models for sending an electronic advertisement to a predetermined mobile website on a network of mobile websites.

Appendices 3-5 show various exemplary methods used for calibration of various exemplary predetermined models based on click-through rates.

Appendix 6 shows an exemplary method for which the confidence of the predetermined model with the highest associated click-through rate may be determined.

### DETAILED DESCRIPTION OF THE INVENTION

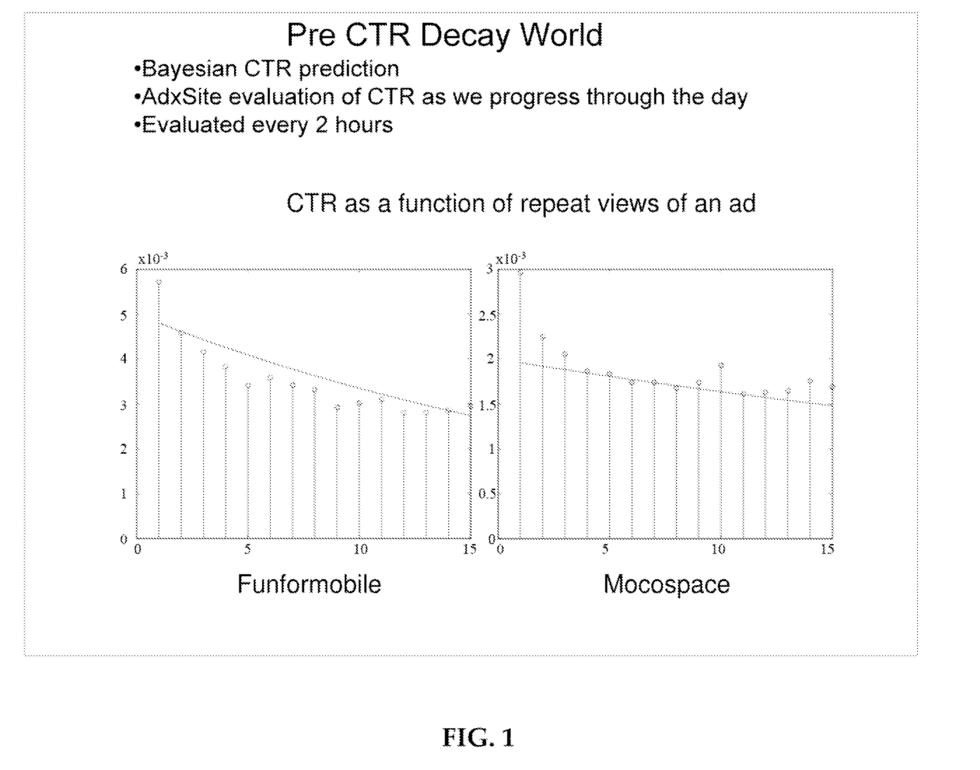

FIG. 1 shows click-through rate (“CTR”) characteristics in general, based on advertisements and websites. Content is information that is displayed to a user of a networked electronic communications device. Content may be in the form of an impression. For example, advertisements (“ads”) are a kind of content that may be shown on an impression as viewed on a user's electronic communications device, which may include a desktop computer, a laptop computer, a mobile phone, a personal digital assistant, or other similar device. Further, such content may be paid for by an advertiser based on the number of times the user may click, click-through, double-click, highlight, and/or otherwise interact with such content (e.g., by clicking a link on the content). Alternatively, such content may be paid for by an advertiser based on the number of impressions (e.g., CPM) delivered to a user's electronic communications device.

Currently, there are content delivery services that deliver ads to users of networked electronic communication devices. Content delivery services typically create and/or maintain an inventory of ads on behalf of advertisers. Content delivery services commonly enter into contracts with advertisers, wherein the advertiser may pay for the sending or delivery of their ads to users on a pay-per-click-per-impression basis (“pay-per-click”). That is, advertisers may want to pay for the display of their ads on user devices based on the number of times that a given user clicks an ad displayed to the user.

An advertiser advertising on a content delivery service on a pay-per-click basis may contractually agree in advance to pay up to a certain fixed amount (“budget”) during a particular period of time for each time a user clicks an advertisement sponsored by that advertiser. For example, an advertiser may agree to pay up to one-thousand dollars ($1000.00) per day at the rate of one-dollar ($1.00) per-click for each time a user clicks an impression that includes the advertiser's ad. Accordingly, the content delivery service sending the ad may realize revenue of up to $1000.00 per day from that advertiser, provided that one thousand impressions are clicked by users during that time period.

Alternatively, an advertiser advertising on a content delivery service on a pay-per-click basis may agree in advance to pay an unlimited amount (i.e. an unlimited budget) for each time a user clicks an ad sponsored by that advertiser. For example, an advertiser may agree to pay the rate of two-dollars ($2.00) per-click for each time a user clicks an impression that includes the advertiser's ad, with an unlimited budget as to how much the advertiser is willing to pay the content delivery service at the end of a particular time period.

In both scenarios, the content delivery service may have a finite number of opportunities during a particular period of time in which to send an impression that includes an ad. The number of times individual users click on an impression that includes an ad (“click rate”) may vary widely and may depend on such factors as the particular ad, user, device, time of day, and so forth. On one hand, the content delivery service may desire to deliver or send those impressions having the highest click rate and/or the highest pay-per-click rate in order to produce the highest immediate revenue. On the other hand, the content delivery service may desire to deliver or send those impressions that may produce the highest revenue over a particular period of time and/or deplete (in dollar value) as much as possible of the budgets established by advertisers for that particular period of time.

Still, problems remain based on differences that exist between various websites, portals, and/or hosts that receive and/or display the content sent by the delivery service. These websites, portals, and/or hosts may exist on any network, including mobile networks, local area networks, and/or the Internet. For example, regardless of the content, one website might experience a higher click-rate than another website. Further, one website might experience a higher click-rate than another website during certain times of the day. Additionally, one website might experience a higher click-rate based upon the nature of the content displayed than another website with the same content. These variables are just a few of the variables addressed herein.

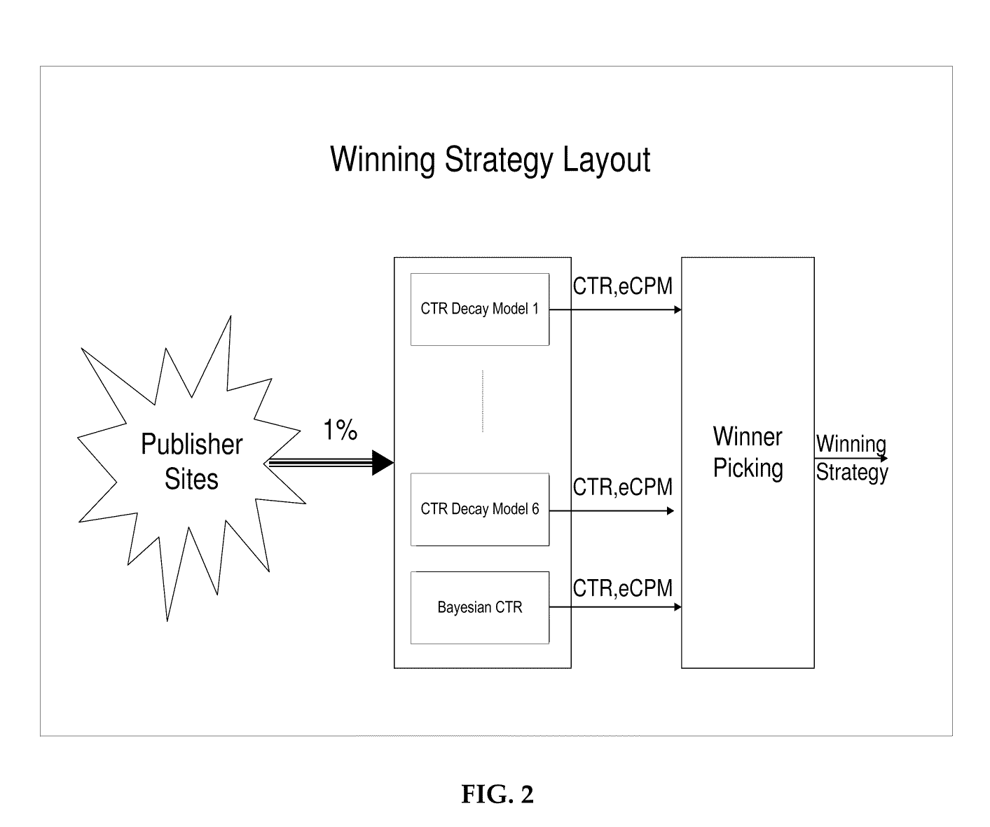

FIG. 2 shows an exemplary layout by which a predetermined model (i.e. “winning strategy”) with the highest associated click-through rate may be determined. Very briefly stated, samplings of an electronic advertisement are sent to a website per various models. The model with the best result is selected. Accordingly, an advertising campaign per the winning strategy is initiated by the electronic advertisement being sent to the website per the selected model.

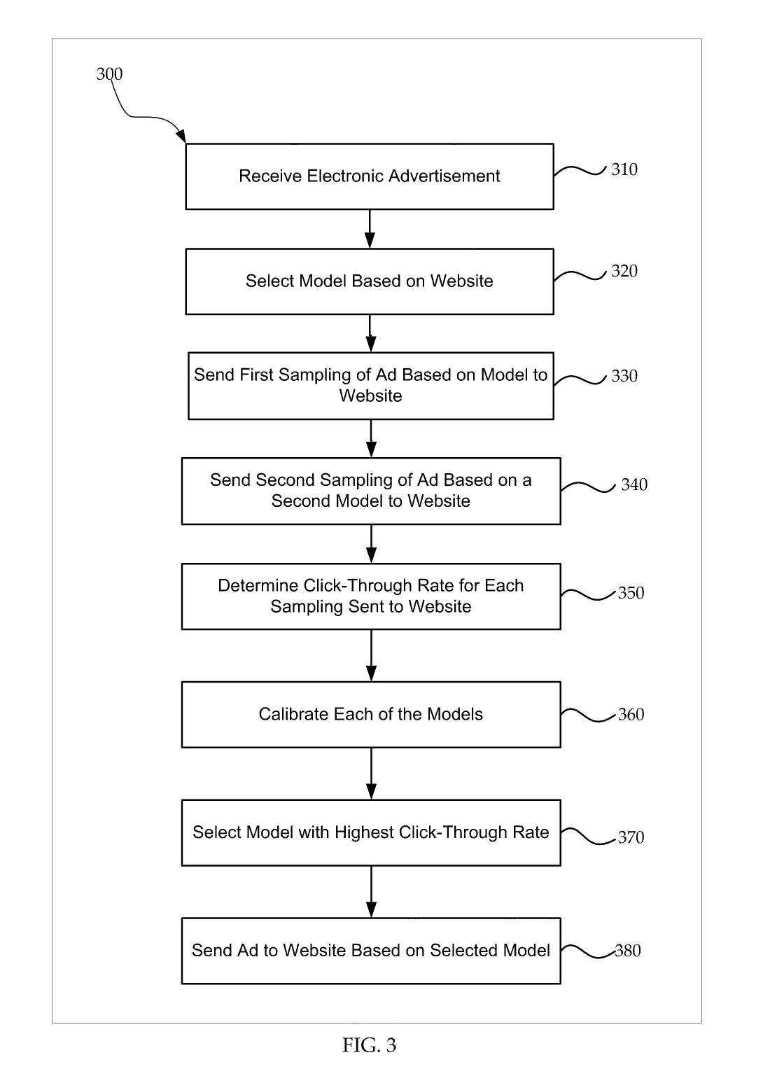

FIG. 3 is a flow chart of an exemplary method 300 for sending an electronic advertisement to a predetermined mobile website on a network of mobile websites.

At step 310, an electronic advertisement may be received by a content delivery service from an advertiser for sending to a predetermined mobile website on a network of mobile websites.

At step 320, a first predetermined model that best fits a click-through rate for the predetermined mobile website is selected. Appendix 1 is an exemplary predetermined model that may be selected. Such a predetermined model is selected independent of the received electronic advertisement. That is, the received electronic advertisement has no or little influence on the selection of the predetermined model. Appendix 2 shows additional exemplary predetermined models for sending an electronic advertisement to a predetermined mobile website on a network of mobile websites.

At step 330, a first sampling of the electronic advertisement is sent to the predetermined mobile website per the first selected predetermined model. According to one embodiment, the sampling may comprise from ten to ten-thousand impressions.

At step 340, a second sampling of the electronic advertisement is sent to the predetermined mobile website per a second predetermined model.

At step 350, a click-through rate for each sampling of electronic advertisements sent to the predetermined mobile website per each of the respective predetermined models is determined.

At step 360, each of the predetermined models is calibrated based on its associated click-through rate. In one embodiment, the calibration may be based on a least squares analysis. Appendices 3-5 show various exemplary methods used for calibration of various exemplary predetermined models based on click-through rates.

At step 370, the predetermined model with the highest associated click-through rate is selected. Appendix 6 shows an exemplary method for which the confidence of the predetermined model with the highest associated click-through rate may be determined.

At step 308, the electronic advertisement is sent to the predetermined mobile website per the selected model.

According to further embodiments, the method may be performed for multiple samplings (without limitation) per other predetermined models. For example, with respect to the example of FIG. 3, a third sampling of the electronic advertisement may be sent to the predetermined mobile website per a third predetermined model. Likewise, a click-through rate for the third sampling of the electronic advertisements sent to the predetermined mobile website per the third predetermined model may be determined, the third predetermined model may be calibrated based on its associated click-through rate, the predetermined model with the highest associated click-through rate may be selected, and the electronic advertisement may be sent to the predetermined mobile website per the selected model.

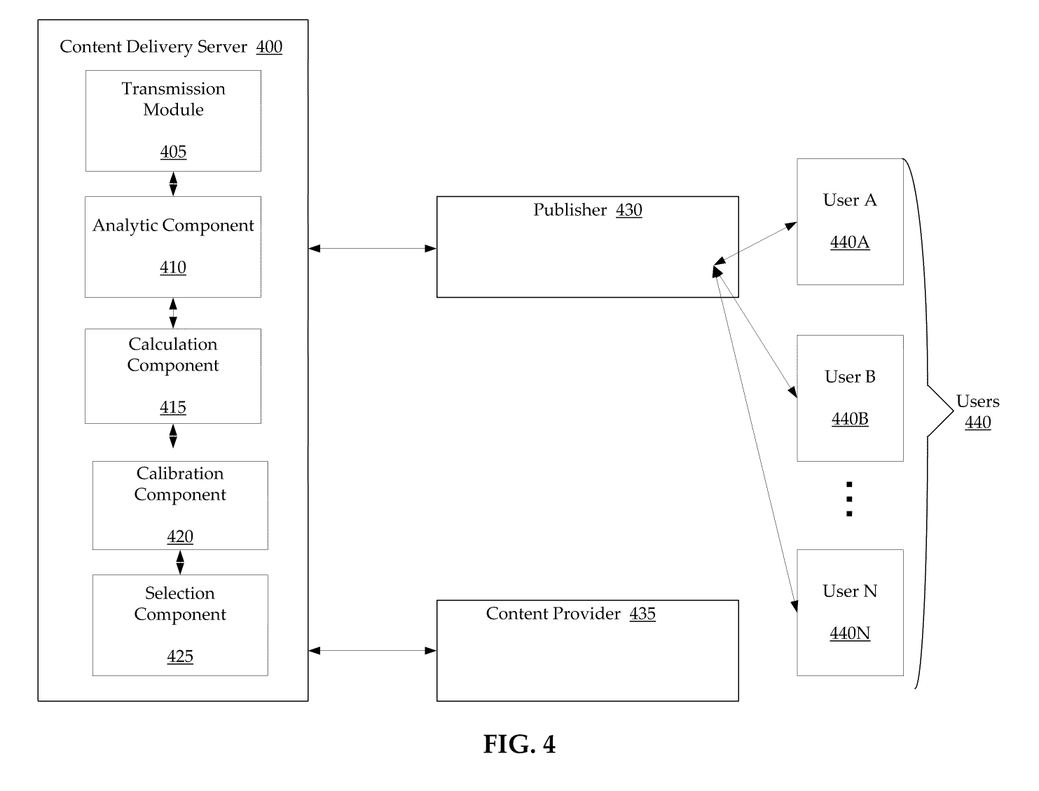

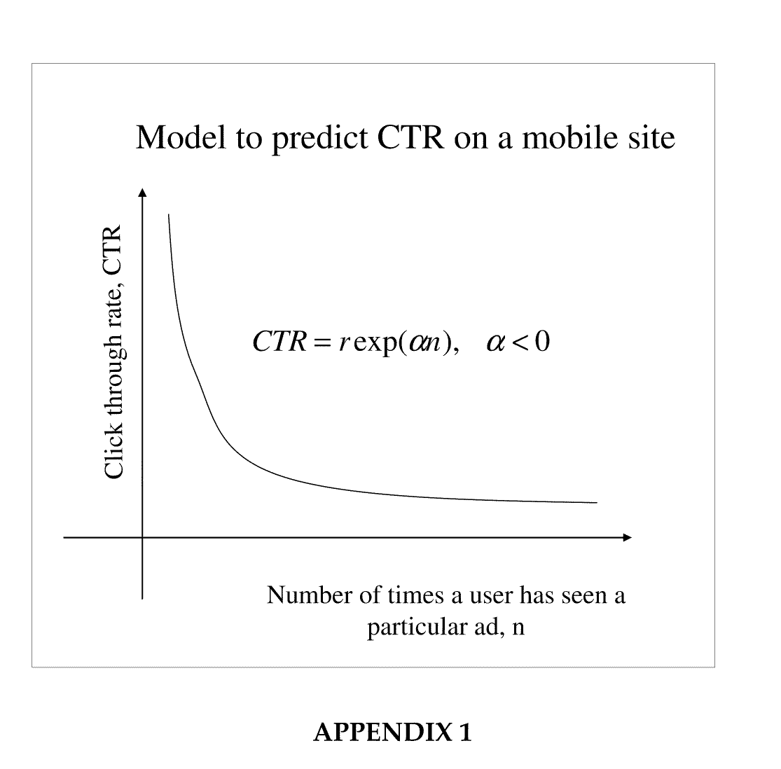

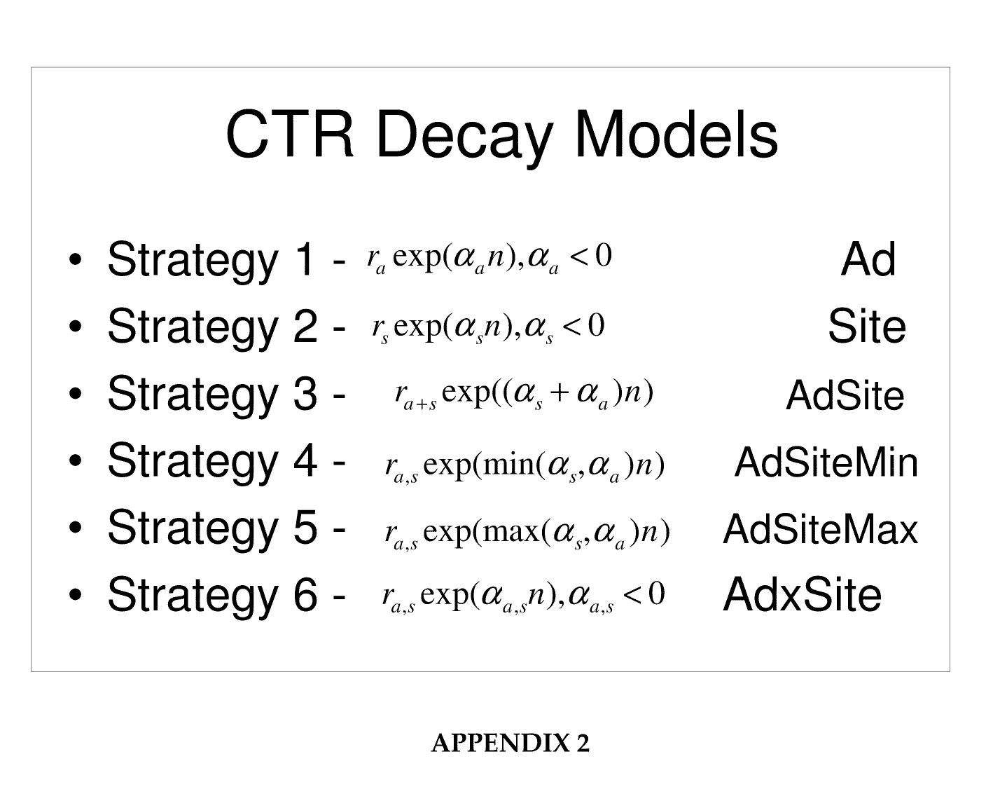

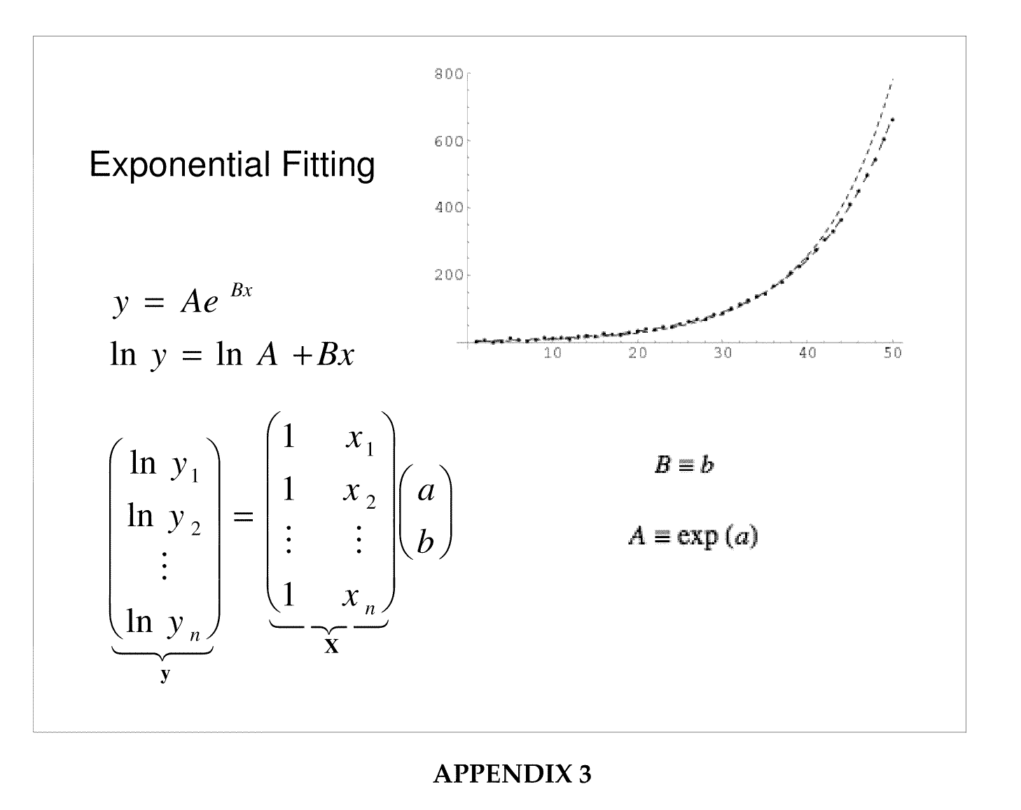

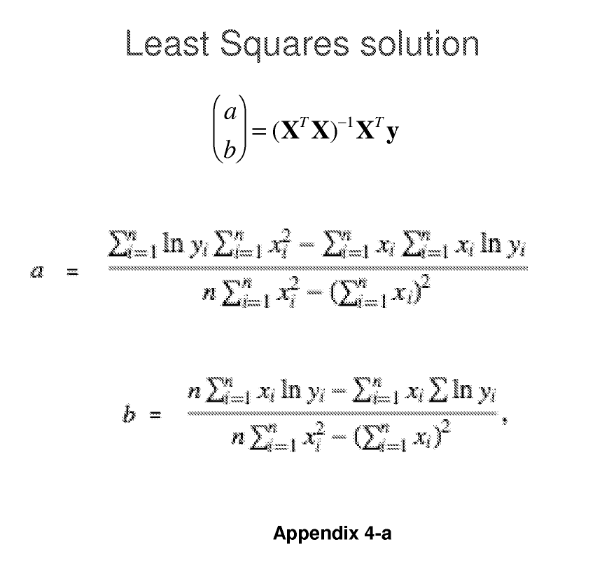

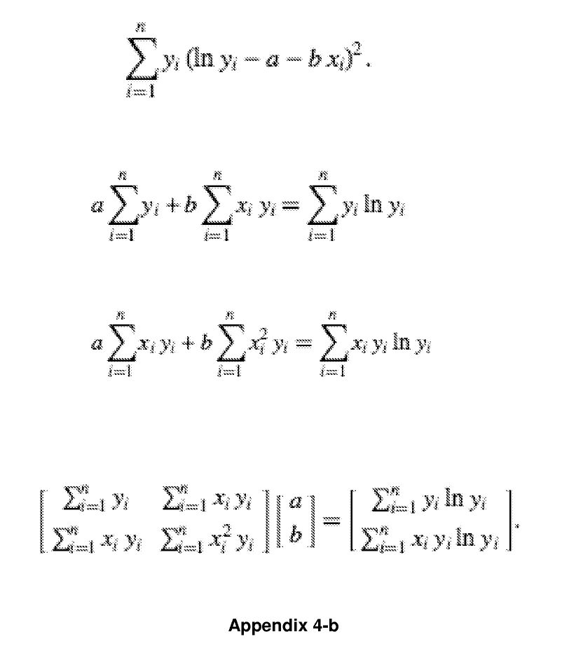

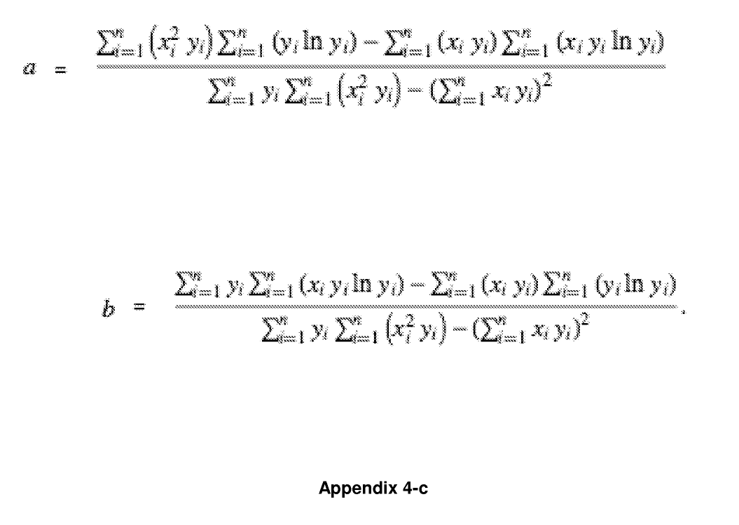

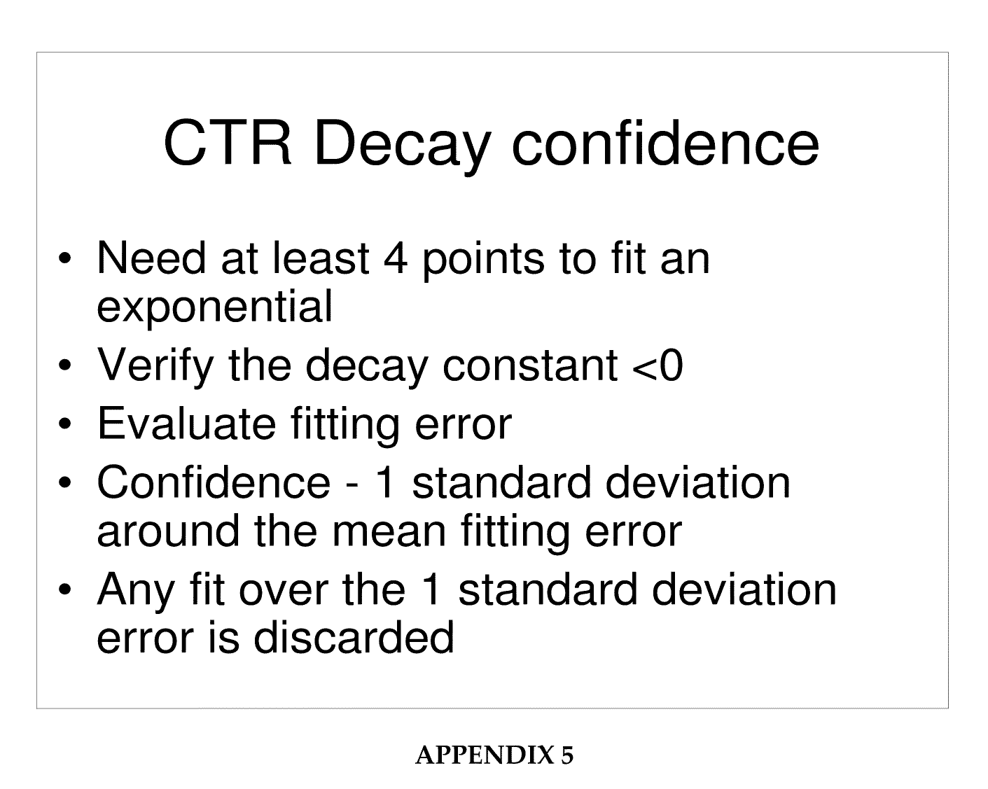

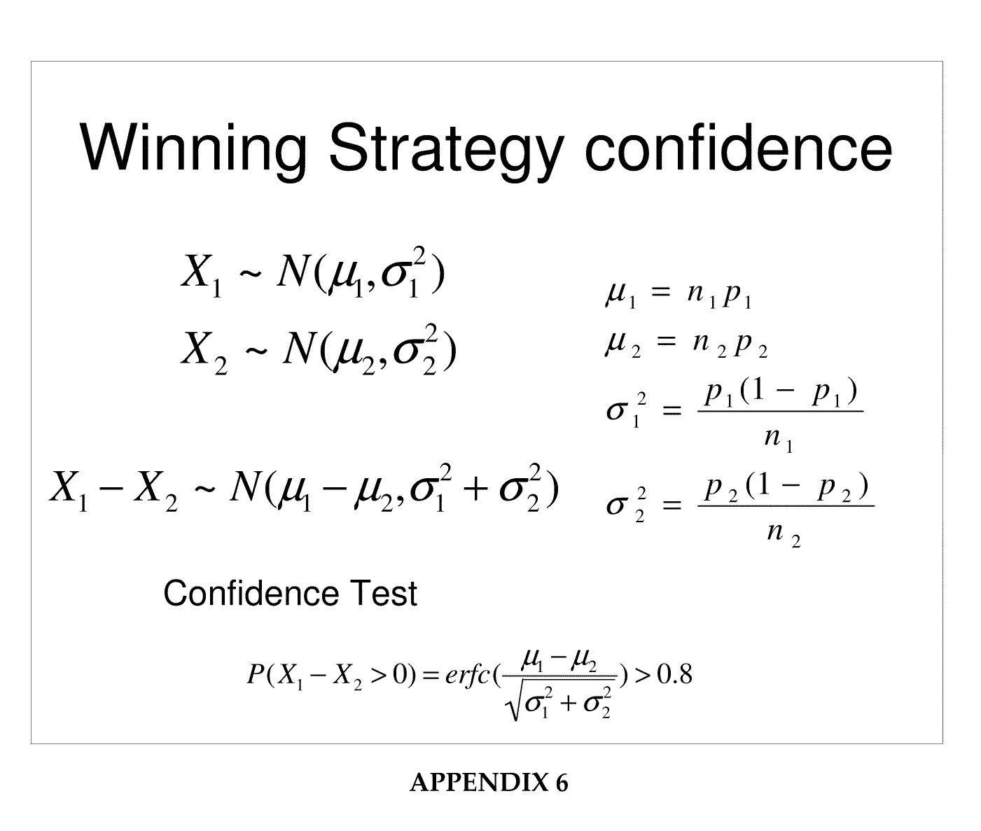

FIG. 4 shows one exemplary system for sending an electronic advertisement to a predetermined mobile website on a network of mobile websites.

Various embodiments may include a system for sending an electronic advertisement to a predetermined mobile website on a network of mobile websites. The system may include a communications interface, a computer readable storage medium, and a processor. The computer readable storage medium may further comprise instructions for execution by the processor. The instructions for execution by the processor cause the processor to send an electronic advertisement to a predetermined mobile website on a network of mobile websites. The processor may execute other instructions described herein and remain within the scope of contemplated embodiments.

Another embodiment may include a computer readable storage medium having a computer readable code for operating a computer to perform a method of sending an electronic advertisement to a predetermined mobile website on a network of mobile websites. Examples of computer readable storage medium may include discs, memory cards, servers and/or computer discs. Instructions may be retrieved and executed by a processor. Some examples of instructions include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments.

Referring to the exemplary system for sending an electronic advertisement to a predetermined mobile website on a network of mobile websites shown in FIG. 4, the system includes content delivery server 400, transmission module 405, analytic component 410, calculation component 415, calibration component 420, and selection component 425. The system also includes publisher 430, content provider 435, and users 440. Users 440 include specific users 440A through 440N.

According to various exemplary systems, the transmission module 405 receives an electronic advertisement for sending to the predetermined mobile website, such as publisher 430, on the network of mobile websites. The analytic component 410 determines for the predetermined mobile website a first predetermined model that best fits a click-through rate for the predetermined mobile website. The transmission module 405 sends a first sampling of the electronic advertisement to the predetermined mobile website per the first predetermined model. The transmission module then sends a second sampling of the electronic advertisement to the predetermined mobile website per a second predetermined model as determined by the analytic component 410.

The calculation component 415, according to one exemplary system, determines a click-through rate for each sampling of electronic advertisements sent to the predetermined mobile website for each of the respective predetermined models. The calibration component 420 calibrates each of the predetermined models based on its associated click-through rate. The selection component 425 selects the predetermined model with the highest associated click-through rate, and the transmission module 405 sends the electronic advertisement to the predetermined mobile website per the calibrated selected predetermined model.

In one exemplary system, content provider 435, comprises a web server (not shown) that may provide content to a content delivery service. An example of a content provider 435 is an entity that produces an advertisement, such as Starbuck's Coffee. The publisher 430 may comprise a publisher of displays for mobile devices, such as ESPN Mobile Web. Users 440 may comprise any user of an electronic communications device, which may include a desktop computer, a laptop computer, a mobile phone (e.g., Blackberry or an iPhone), a personal digital assistant, or other similar device.

While various exemplary systems and methods have been described herein, it should be understood that they have been presented by way of example only, and not limitation. Thus, the breadth and scope of a preferred system and/or method should not be limited by any of the above-described exemplary descriptions.

What is claimed is:

1. A method for sending an electronic advertisement to a predetermined mobile website on a network of mobile websites, the method comprising:
receiving an electronic advertisement for sending to the predetermined mobile website on the network of mobile websites;
determining for the predetermined mobile website a first predetermined model that best fits a click-through rate for the predetermined mobile website;
sending a first sampling of the electronic advertisement to the predetermined mobile website per the first predetermined model;
sending a second sampling of the electronic advertisement to the predetermined mobile website per a second predetermined model;
determining a click-through rate for each sampling of electronic advertisements sent to the predetermined mobile website for each of the respective predetermined models;
calibrating each of the predetermined models based on its associated click-through rate;
selecting the predetermined model with the highest associated click-through rate; and
sending the electronic advertisement to the predetermined mobile website per the calibrated selected predetermined model.

2. The method of claim 1, the method further comprising:
sending a third sampling of the electronic advertisement to the predetermined mobile website per a third predetermined model;
determining a click-through rate for the third sampling of electronic advertisements sent to the predetermined mobile web site per the third predetermined model;
calibrating the third predetermined model based on its associated click-through rate;
selecting the predetermined model with the highest associated click-through rate; and
sending the electronic advertisement to the predetermined mobile website per the calibrated selected predetermined model.

3. The method of claim 2, the method further comprising:
sending a fourth sampling of the electronic advertisement to the predetermined mobile website per a fourth predetermined model;
determining a click-through rate for the fourth sampling of electronic advertisements sent to the predetermined mobile website per the fourth predetermined model;
calibrating the fourth predetermined model based on its associated click-through rate;
selecting the predetermined model with the highest associated click-through rate; and
sending the electronic advertisement to the predetermined mobile website per the calibrated selected predetermined model.

4. The method of claim 3, the method further comprising:
sending a fifth sampling of the electronic advertisement to the predetermined mobile website per a fifth predetermined model;
determining a click-through rate for the fifth sampling of electronic advertisements sent to the predetermined mobile website per the fifth predetermined model;
calibrating the fifth predetermined model based on its associated click-through rate;
selecting the predetermined model with the highest associated click-through rate; and
sending the electronic advertisement to the predetermined mobile website per the calibrated selected predetermined model.

5. The method of claim 4, the method further comprising:
sending a sixth sampling of the electronic advertisement to the predetermined mobile website per a sixth predetermined model;
determining a click-through rate for the sixth sampling of electronic advertisements sent to the predetermined mobile website per the sixth predetermined model;
calibrating the sixth predetermined model based on its associated click-through rate;
selecting the predetermined model with the highest associated click-through rate; and
sending the electronic advertisement to the predetermined mobile website per the calibrated selected predetermined model.

6. A method for sending an electronic advertisement to a predetermined mobile website on a network of mobile websites, the method comprising:
receiving an electronic advertisement for sending to the predetermined mobile website on the network of mobile websites;
determining for the predetermined mobile website a first predetermined model that best fits a click-through rate for the predetermined mobile website;
sending a first sampling of the electronic advertisement to the predetermined mobile website per the first predetermined model;
sending a second sampling of the electronic advertisement to the predetermined mobile website per a second predetermined model;
sending a third sampling of the electronic advertisement to the predetermined mobile website per a third predetermined model;
sending a fourth sampling of the electronic advertisement to the predetermined mobile website per a fourth predetermined model;
sending a fifth sampling of the electronic advertisement to the predetermined mobile website per a fifth predetermined model;
sending a sixth sampling of the electronic advertisement to the predetermined mobile website per a sixth predetermined model;
determining a click-through rate for each sampling of electronic advertisements sent to the predetermined mobile website for each of the respective predetermined models;
calibrating each of the predetermined models based on its associated click-through rate;
selecting the predetermined model with the highest associated click-through rate; and
sending the electronic advertisement to the predetermined mobile website per the calibrated selected predetermined model.

7. The method of claim 6, the method further comprising:
sending a subsequent sampling of the electronic advertisement to the predetermined mobile website per a subsequent predetermined model;
determining a click-through rate for the subsequent sampling of electronic advertisements sent to the predetermined mobile website for the subsequent predetermined model;
calibrating the subsequent predetermined model based on its associated click-through rate;
selecting the predetermined model with the highest associated click-through rate; and
sending the electronic advertisement to the predetermined mobile website per the calibrated selected predetermined model.

8. A computer readable storage medium having embodied thereon a program, the program being executable by a processor to perform a method for sending an electronic advertisement to a predetermined mobile website on a network of mobile websites, the method comprising:
receiving an electronic advertisement for sending to the predetermined mobile website on the network of mobile websites;
determining for the predetermined mobile website a first predetermined model that best fits a click-through rate for the predetermined mobile website;
sending a first sampling of the electronic advertisement to the predetermined mobile website per the first predetermined model;
sending a second sampling of the electronic advertisement to the predetermined mobile website per a second predetermined model;
determining a click-through rate for each sampling of electronic advertisements sent to the predetermined mobile website for each of the respective predetermined models;
calibrating each of the predetermined models based on its associated click-through rate;
selecting the predetermined model with the highest associated click-through rate; and
sending the electronic advertisement to the predetermined mobile website per the calibrated selected predetermined model.

9. The computer readable storage medium of claim 8, the method further comprising:
sending a third sampling of the electronic advertisement to the predetermined mobile website per a third predetermined model;
determining a click-through rate for the third sampling of electronic advertisements sent to the predetermined mobile website per the third predetermined model;
calibrating the third predetermined model based on its associated click-through rate;
selecting the predetermined model with the highest associated click-through rate; and
sending the electronic advertisement to the predetermined mobile website per the calibrated selected predetermined model.

10. The computer readable storage medium of claim 9, the method further comprising:
sending a fourth sampling of the electronic advertisement to the predetermined mobile website per a fourth predetermined model;
determining a click-through rate for the fourth sampling of electronic advertisements sent to the predetermined mobile website per the fourth predetermined model;
calibrating the fourth predetermined model based on its associated click-through rate;
selecting the predetermined model with the highest associated click-through rate; and
sending the electronic advertisement to the predetermined mobile website per the calibrated selected predetermined model.

11. The computer readable storage medium of claim 10, the method further comprising:
sending a fifth sampling of the electronic advertisement to the predetermined mobile website per a fifth predetermined model;
determining a click-through rate for the fifth sampling of electronic advertisements sent to the predetermined mobile website per the fifth predetermined model;
calibrating the fifth predetermined model based on its associated click-through rate;
selecting the predetermined model with the highest associated click-through rate; and
sending the electronic advertisement to the predetermined mobile website per the calibrated selected predetermined model.

12. The computer readable storage medium of claim 11, the method further comprising:
sending a sixth sampling of the electronic advertisement to the predetermined mobile website per a sixth predetermined model;
determining a click-through rate for the sixth sampling of electronic advertisements sent to the predetermined mobile website per the sixth predetermined model;
calibrating the sixth predetermined model based on its associated click-through rate;
selecting the predetermined model with the highest associated click-through rate; and
sending the electronic advertisement to the predetermined mobile website per the calibrated selected predetermined model.

13. A computer readable storage medium having embodied thereon a program, the program being executable by a processor to perform a method for sending an electronic advertisement to a predetermined mobile website on a network of mobile websites, the method comprising:
receiving an electronic advertisement for sending to the predetermined mobile website on the network of mobile websites;
determining for the predetermined mobile website a first predetermined model that best fits a click-through rate for the predetermined mobile website;
sending a first sampling of the electronic advertisement to the predetermined mobile website per the first predetermined model;
sending a second sampling of the electronic advertisement to the predetermined mobile website per a second predetermined model;
sending a third sampling of the electronic advertisement to the predetermined mobile website per a third predetermined model;
sending a fourth sampling of the electronic advertisement to the predetermined mobile website per a fourth predetermined model;
sending a fifth sampling of the electronic advertisement to the predetermined mobile website per a fifth predetermined model;
sending a sixth sampling of the electronic advertisement to the predetermined mobile website per a sixth predetermined model;
determining a click-through rate for each sampling of electronic advertisements sent to the predetermined mobile website for each of the respective predetermined models;
calibrating each of the predetermined models based on its associated click-through rate;
selecting the predetermined model with the highest associated click-through rate; and
sending the electronic advertisement to the predetermined mobile website per the calibrated selected predetermined model.

14. The computer readable storage medium of claim 13, the method further comprising:
sending a subsequent sampling of the electronic advertisement to the predetermined mobile website per a subsequent predetermined model;
determining a click-through rate for the subsequent sampling of electronic advertisements sent to the predetermined mobile website for the subsequent predetermined model;
calibrating the subsequent predetermined model based on its associated click-through rate;
selecting the predetermined model with the highest associated click-through rate; and
sending the electronic advertisement to the predetermined mobile website per the calibrated selected predetermined model.

15. A system for sending an electronic advertisement to a predetermined mobile website on a network of mobile websites, the system comprising:
a transmission module for receiving an electronic advertisement for sending to the predetermined mobile website on the network of mobile websites;
an analytic component in communication with the transmission module, the analytic component determining for the predetermined mobile website a first predetermined model that best fits a click-through rate for the predetermined mobile website;
the transmission module sending a first sampling of the electronic advertisement to the predetermined mobile website per the first predetermined model;
the transmission module sending a second sampling of the electronic advertisement to the predetermined mobile website per a second predetermined model as determined by the analytic component;
a calculation component in communication with the transmission module and the analytic component, the calculation component determining a click-through rate for each sampling of electronic advertisements sent to the predetermined mobile website for each of the respective predetermined models;
a calibration component in communication with the transmission module, the analytic component, and the calculation component, the calibration component calibrating each of the predetermined models based on its associated click-through rate;
a selection component in communication with the transmission module, the analytic component, the calculation component, and the calibration component, the selection component selecting the predetermined model with the highest associated click-through rate; and
the transmission module sending the electronic advertisement to the predetermined mobile website per the calibrated selected predetermined model.

16. The system of claim 15, the system further comprising:
the transmission module sending a third sampling of the electronic advertisement to the predetermined mobile website per a third predetermined model;
the calculation component determining a click-through rate for the third sampling of electronic advertisements sent to the predetermined mobile website per the third predetermined model;
the calibration component calibrating the third predetermined model based on its associated click-through rate;
the selection component selecting the predetermined model with the highest associated click-through rate; and
the transmission module sending the electronic advertisement to the predetermined mobile website per the calibrated selected predetermined model.

17. The system of claim 16, the system further comprising:
the transmission module sending a fourth sampling of the electronic advertisement to the predetermined mobile website per a fourth predetermined model;
the calculation component determining a click-through rate for the fourth sampling of electronic advertisements sent to the predetermined mobile website per the fourth predetermined model;
the calibration component calibrating the fourth predetermined model based on its associated click-through rate;
the selection component selecting the predetermined model with the highest associated click-through rate; and
the transmission module sending the electronic advertisement to the predetermined mobile website per the calibrated selected predetermined model.

18. The system of claim 17, the system further comprising:
the transmission module sending a fifth sampling of the electronic advertisement to the predetermined mobile website per a fifth predetermined model;
the calculation component determining a click-through rate for the fifth sampling of electronic advertisements sent to the predetermined mobile website per the fifth predetermined model;
the calibration component calibrating the fifth predetermined model based on its associated click-through rate;
the selection component selecting the predetermined model with the highest associated click-through rate; and
the transmission module sending the electronic advertisement to the predetermined mobile website per the calibrated selected predetermined model.

19. The system of claim 18, the system further comprising:
the transmission module sending a sixth sampling of the electronic advertisement to the predetermined mobile website per a sixth predetermined model;
the calculation component determining a click-through rate for the sixth sampling of electronic advertisements sent to the predetermined mobile website per the sixth predetermined model;
the calibration component calibrating the sixth predetermined model based on its associated click-through rate;
the selection component selecting the predetermined model with the highest associated click-through rate; and
the transmission module sending the electronic advertisement to the predetermined mobile website per the calibrated selected predetermined model.

20. The system of claim 15, wherein the network of mobile websites is an Internet network, a cellular network or a combination thereof.
